(19) United States
(12) Patent Application Publication
(10) Pub. No.: US 2008/0098613 A1
(43) Pub. Date: May 1, 2008

(54) DRYING CYLINDER

(76) Inventors: Stevan Lomic, Wien (AT); Karl Ponweiser, Wiener Neustadt (AT); Friedrich Frass, Wien (AT)

Correspondence Address: Todd T. Taylor;Taylor & Aust, P.C., P.O. Box 560, 142 S. Main Street, Avilla, IN, 46710, US

(21) Appl. No.: 11/930,965

(22) Filed: Oct. 31, 2007

Related U.S. Application Data
(63) Continuation of application No. PCT/EP2006/061052, filed on Mar. 27, 2006.

(30) Foreign Application Priority Data
May 13, 2005 (DE) 10 2005 022 233.1

(51) Int. Cl. F26B 11/02

(52) U.S. Cl. 34/124

(57) ABSTRACT

The invention relates to a drying cylinder for drying a paper, cardboard, tissue or other fibrous web in a machine for manufacturing and/or finishing the former, which is heated from inside with a gaseous heat transfer medium, the inner side of the roll shell having elevations which protrude out of the condensation of the heat transfer medium which collects on the inner side. Here, the heat transfer is to be improved by the fact that the elevations are at least 1.2 times higher than the mean condensation height and/or the cross section of the elevations is reduced inwards.

### CROSS REFERENCE TO RELATED APPLICATIONS

This is a continuation of PCT application No. PCT/EP2006/061052, entitled “DRYING CYLINDER”, filed Mar. 27, 2006, which is incorporated herein by reference.

### BACKGROUND OF THE INVENTION

1. Field of the Invention

The invention relates to a drying cylinder for drying a paper, board, tissue or another fibrous web in a machine for producing and/or finishing the same, which is heated from the inside with a gaseous, condensable heat transfer medium, the inside of the roll shell having elevations which protrude out of the condensate of the heat transfer medium collecting on the inside.

2. Description of the Related Art

Drying cylinders of this type have been known for a long time, steam predominantly being used as the heating medium.

As a result of the extraction of heat during the drying of the fibrous web, a phase transition occurs and therefore the formation of condensate. At the usual machine speeds, as a result of centrifugal force, this condensate is deposited on the inside of the roll shell as a closed condensate ring.

This condensate ring is thermally highly insulating and thus worsens the heat transfer from the steam to the fibrous web.

Therefore, drying cylinders having grooves extending radially have been developed, their ribs protruding slightly out of the condensate.

However, this increasingly no longer meets the requirements for improved heat transfer, in particular in the event of a fluctuating thickness of the condensate ring. In addition, carrying the condensate away out of the radial grooves is problematic.

What is needed in the art is to improve the heat transfer with simple measures.

### SUMMARY OF THE INVENTION

The present invention provides that the elevations have at least 1.2 times the height of the average condensate height and/or the cross section of the elevations decreases toward the inside (that is, in an inward radial direction of the roll shell).

In this case, the elevations protrude considerably out of the condensate film and, because of their direct contact with the gaseous heat transfer medium, improve the heat transfer substantially.

The widening of the cross-sectional area of the elevations toward the roll shell increases the thermal conductivity. In addition, this results in an increase in the quantity of condensate arising, leading to an enlargement of the condensate thickness only to a reduced extent, because of the free area between the elevations, which increases with increasing height.

In order to offer an adequate contact surface between the elevations and the gaseous heat transfer medium, the elevations should have at least 1.2 times, preferably 1.5 times and in particular 1.8 times the height of the average condensate height.

In this case, however, it is sufficient if the elevations have at most 10 times, preferably at most 5 times, the height of the average condensate height.

In many cases, in order to ensure adequate heat transport, it may already be sufficient if the elevations have at most 2 times, preferably at most 1.8 times, the height of the average condensate height.

For optimal heat transport, it is advantageous if the cross-sectional reduction in the size of the elevations is carried out in such a way that an approximately constant heat flow density prevails in the elevations.

Furthermore, the cross-sectional area of all the elevations on the inside should correspond approximately to half the inner shell area of the roll shell.

In this case, the size and spacing of the elevations should be chosen in such a way that, on the outside of the roll shell, which is contacted by the fibrous web, only the smallest possible temperature differences prevail between the regions opposite the elevations and the regions opposite the condensate surface.

In order to minimize the expenditure, the use of steam as heat transfer medium is recommended.

In this case, it is possible for the elevations and the roll shell to consist of the same, highly thermally conductive material.

This makes it possible to design the elevations and the roll shell in one piece.

For example, the elevations could be machined out of the roll shell by milling.

However, it may also be advantageous if the elevations consist of a different material with a good thermal conductivity, preferably better than the roll shell.

Here, it is a matter of a highly thermally conductive connection between elevations and the roll shell. Therefore, the fixing of the elevations to the roll shell can preferably be carried out by way of soldering, welding or adhesive bonding.

A relatively fine-mesh distribution of the elevations is possible if these have, at least to some extent, the form of pins or studs.

Another design results if the elevations have, at least to some extent, the form of ribs.

These ribs can extend axially, radially or spirally.

However, it is advantageous if the ribs extend axially. In order in this case to be able to lead the accumulating condensate away easily, the ribs at at least one shell end should lead to a connecting channel extending radially on the inner shell surface. From this connecting channel, the condensate can then easily be led out of the drying cylinder, for example with a stationary siphon.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic axial cross section through one end of a drying cylinder; and

FIG. 2 shows a schematic radial cross section through the drying cylinder.

Corresponding reference characters indicate corresponding parts throughout the several views. The exemplifications set out herein illustrate one embodiment of the invention, and such exemplifications are not to be construed as limiting the scope of the invention in any manner.

### DETAILED DESCRIPTION OF THE INVENTION

The drying of fibrous webs in production machines is carried out to a substantial extent by way of contact with the heated circumferential surface of rotating drying cylinders as they wrap around them.

For the purpose of simplification, the drying cylinders are in this case normally heated with hot steam. To this end, the latter is led into the interior of the drying cylinder.

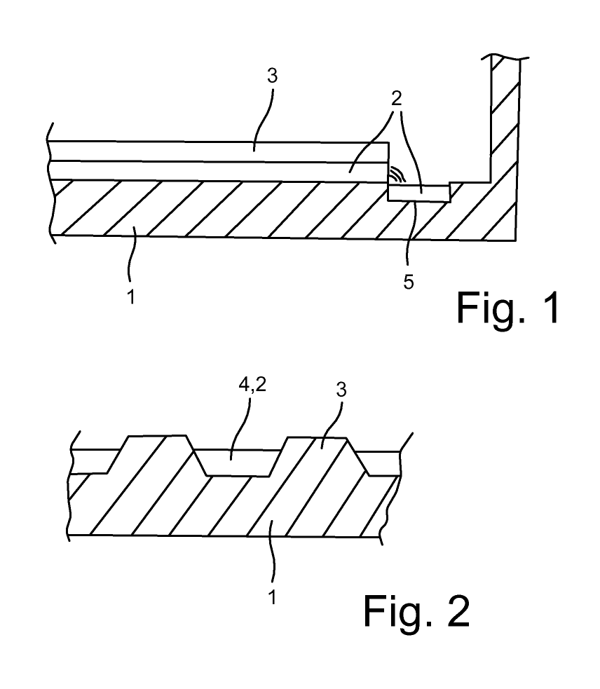

Referring now to the drawings, and more particularly to FIG. 1, there is shown as a result of the extraction of heat during the drying, the formation of condensate which occurs on the inside of the roll shell 1 of the drying cylinder.

Since this condensate 2 is deposited on the inside as a closed and thermally insulating condensate layer, because of centrifugal force, measures have to be taken in order to improve the heat transfer from the steam to the fibrous web via the roll shell.

To this end, the roll shell 1 has on its inside a large number of ribs 3 arranged distributed uniformly over the circumference and extending axially.

In the interests of a good thermal connection, these ribs 3 are soldered onto the inside or otherwise connected in a highly thermally conductive manner. Like the roll shell 1, they also consist of a highly thermally conductive material and protrude out of the condensate layer.

As a result of the direct contact between the steam and the part of the ribs 3 protruding out of the condensate 2, the heat transfer to the roll shell 1 is improved considerably.

As illustrated in FIG. 1, the ribs 3 at the end of the roll shell 1 lead to a collecting channel 5 extending radially. The base of the grooves 4 present between the ribs 3 for the condensate 2 is radially further in than the base of the collecting channel 5, so that the condensate 2 flows out of the grooves 4 into the collecting channel 5. From the collecting channel 5, the condensate 2 can be led out of the drying cylinder without problems, for example via a stationary siphon.

As can be seen in FIG. 2, the ribs 3 have a trapezoidal cross section, that is to say the cross section tapers, starting from the inside of the roll shell 1. This improves the thermal conductivity toward the roll shell 1 and ensures that an increase in the quantity of condensate arising leads to an enlargement of the condensate thickness only to a reduced extent, because of the groove area between the ribs 3 increasing with increasing height. This makes the effect less dependent.

The average condensate height is generally between 2 and 10 mm, in particular between 3 and 5 mm, the ribs 3 having 1.3 to 1.6 times the height thereof.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A drying cylinder for drying a web of fibrous material in a machine for at least one of producing and finishing the web, the drying cylinder being heated from an inside area of the drying cylinder with a gaseous heat transfer medium, said drying cylinder comprising:
a roll shell including an inside portion having a plurality of elevations configured for protruding out of a condensate of the gaseous heat transfer medium collecting on said inside portion, at least one of said plurality of elevations each having a height that is at least 1.2 times as high as an average condensate height and a cross section of each of said plurality of elevations reducing in an inward direction of said roll shell.

2. The drying cylinder as claimed in claim 1, wherein said height is at most 10 times as high as said average condensate height.

3. The drying cylinder as claimed in claim 1, wherein said height is at most 5 times as high as said average condensate height.

4. The drying cylinder as claimed in claim 1, wherein said height is at least 1.5 times as high as said average condensate height.

5. The drying cylinder as claimed in claim 1, wherein said height is at least 1.8 times as high as said average condensate height.

6. The drying cylinder as claimed in claim 1, wherein said height is at most 2 times as high as said average condensate height.

7. The drying cylinder as claimed in claim 1, wherein said height is at most 1.8 times as high as said average condensate height.

8. The drying cylinder as claimed in claim 1, wherein said cross section of each of said plurality of elevations reduces such that an approximately constant heat flow density prevails in said plurality of elevations.

9. The drying cylinder as claimed in claim 1, wherein a cross-sectional area of all of said plurality of elevations on said inside portion corresponds approximately to half an inner shell area of said roll shell.

10. The drying cylinder as claimed in claim 1, wherein the gaseous heat transfer medium is steam.

11. The drying cylinder as claimed in claim 1, wherein said plurality of elevations and said roll shell include a same material.

12. The drying cylinder as claimed in claim 11, wherein said plurality of elevations and said roll shell are designed in one piece.

13. The drying cylinder as claimed in claim 1, wherein said plurality of elevations include a different material with a good thermal conductivity than said roll shell.

14. The drying cylinder as claimed in claim 13, wherein said plurality of elevations are fixed to said roll shell.

15. The drying cylinder as claimed in claim 14, wherein said plurality of elevations are soldered onto said roll shell.

16. The drying cylinder as claimed in claim 14, wherein said plurality of elevations are adhesively bonded to said roll shell.

17. The drying cylinder as claimed in claim 1, wherein said plurality of elevations have, at least to some extent, a form of one of a plurality of pins and a plurality of studs.

18. The drying cylinder as claimed in claim 1, wherein said plurality of elevations have, at least to some extent, a form of a plurality of ribs.

19. The drying cylinder as claimed in claim 18, wherein said plurality of ribs extend one of radially and spirally.

20. The drying cylinder as claimed in claim 18, wherein said plurality of ribs extend axially.

21. The drying cylinder as claimed in claim 20, wherein said roll shell includes a shell end and a collecting channel extending radially, said plurality of ribs at at least one said shell end leads to said collecting channel extending radially.
